(19) United States
(12) Patent Application Publication
(10) Pub. No.: US 2003/0050813 A1
(43) Pub. Date: Mar. 13, 2003

(54) Method and apparatus for automatic transitioning between states in a state machine that manages a business process

(75) Inventors: Mitchell Adam Cohen, Yorktown Heights, NY (US); Titania Mary Gupta, Hawthorne, NY (US); Laurent David Hasson, New York, NY (US); John Scott Houston, Hopewell Junction, NY (US); Esther Yuan Ling Lee, New York, NY (US); Jianren Li, Valhalla, NY (US); Rakesh Mohan, Cortlandt Manor, NY (US); Josef Schiefer, White Plains, NY (US)

Correspondence Address: Ryan, Mason & Lewis, LLP, Suite 205, 1300 Post Road, Fairfield, CT, 06430, US

(73) Assignee: International Business Machines Corporation, Armonk, NY

(21) Appl. No.: 09/951,028

(22) Filed: Sep. 11, 2001

(51) Int. Cl. G06F 17/60

(52) U.S. Cl. 705/7

(57) ABSTRACT

A method and apparatus are disclosed for automatically transitioning between states in a state machine that manages a business process. A state machine is used to represent a business process. The state machine includes a plurality of states, and at least one state includes an entry action that is executed upon entering the state. The present invention provides for automatic state transitions by throwing events upon state entry whenever any conditions associated with the entry action are satisfied. The entry action includes conditional logic that causes an automatic transition to another state if the conditional logic is satisfied. The present invention provides a method to implement complex decision-making logic in one place, thereby allowing the logic to be more easily and consistently defined and maintained.

### CROSS REFERENCE TO RELATED APPLICATIONS

The present invention is related to U.S. patent application entitled “Method and Apparatus for Managing The Versioning of Business Objects Using a State Machine,” (Attorney Docket Number SOM920010006US1), U.S. patent application entitled “Method and Apparatus for Creating and Managing Complex Business Processes,” (Attorney Docket Number SOM920010007US1), U.S. patent application entitled “Method and Apparatus for Monitoring Execution of a Business Process Managed Using a State Machine,” (Attorney Docket Number SOM920010008US1), U.S. patent application entitled “Method and Apparatus for Managing and Displaying User Authorizations for a Business Process Managed Using a State Machine,” (Attorney Docket Number SOM920010009US1) and U.S. patent application entitled “Method and Apparatus for Managing a User Group List For a Business Process Managed Using a State Machine,” (Attorney Docket Number SOM9200100010US1), filed contemporaneously herewith, assigned to the assignee of the present invention and incorporated by reference herein.

### FIELD OF THE INVENTION

The present invention relates generally to techniques for representing business processes as state machines, and more particularly, to a method and apparatus for automatically transitioning between states in a state machine that manages a business process.

### BACKGROUND OF THE INVENTION

Business processes, such as those used to manage auctions, often differ from one business to another only in minor ways, such as the number of approvals required for a transaction. When these minor differences reveal themselves in an online business-to-business system, either new business processes must be created to meet the needs of new customers, or the new customer is forced to alter the way it operates to match a business process already defined in the system for another customer. If new business processes are created, then this comes at the expense of increased storage requirements along with additional system management and maintenance overhead, especially for larger and more involved systems.

At the same time, much of business revolves around making decisions. Typically, these decisions are made by authorized individuals acting on behalf of their organizations, applying a variety of rules or guidelines. The actual decision-making logic may be simple or extremely complex depending upon the needs of the business and the decision being made. However, the demands on decision-makers are rapidly increasing along with the pace of business. This leaves the decision-makers overloaded, many times with trivial decisions, thus decreasing the amount of time that they have to focus on more important decisions.

If there were a way to create flexible business processes that could adapt to meet the needs of the various user organizations, while providing a means for automating some decision-making, the benefits would be considerable. For example, if the number of levels of approval in a business process could be configured in such a way that it appeared to dynamically change at run time to match the requirements of the user organization, then many organizations would be able to share the same business process. If this same mechanism also allowed automatic decision-making support for the more routine decisions, then the workload of the decision-makers could be eased to allow them to focus their attention on the more important matters. Overall, there would be increased flexibility without increased expense or complexity.

A number of different approaches have been attempted to solve these various problems. For example, a collaborative supply chain management approach included, for example, in the WebSphere Business Integrator from IBM Corp., and the event-driven process chain (EPC) system developed by IDS Scheer AG of Germany, provide flexibility in dynamically managing business flows. However, these approaches do not provide the means to define business decision-making logic within the flow which will not only allow steps to be taken automatically based upon intelligent decision-making, but to do so within the same transaction scope to ensure that the updates are atomic. Without the atomicity of updates, business objects could be left in unexpected states.

### SUMMARY OF THE INVENTION

Generally, a method and apparatus are disclosed for automatically transitioning between states in a state machine that manages a business process. The present invention uses a state machine to represent a business process. The state machine includes a plurality of states, and at least one state includes an entry action that is executed upon entering the state. The present invention expands the concept of what can be done from within an entry action. Specifically, the present invention provides for automatic state transitions by throwing events upon state entry whenever any conditions associated with the entry action are satisfied. In other words, if the condition(s) associated with the entry action are satisfied, there is an automatic transition to another identified state.

Thus, according to one aspect of the invention, the entry action includes conditional logic that causes an automatic transition to another state if the conditional logic is satisfied. In an exemplary approval process, the entry action may be associated with an approval pending state and include conditional logic for specifying a threshold that will implicate an affirmative approval process, such as a maximum value of an order. In this manner, the entry action causes a transition to automatically bypass the approval pending state if the threshold is not exceeded.

The present invention thus expands the capabilities of an entry action, and provides a method to implement complex decision-making logic in one place (as opposed to being distributed across several guards as with conventional techniques). By placing the complex decision-making logic in an entry action, the logic is more easily and consistently defined and maintained.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary conventional state machine having two states for managing a business process;

FIG. 2 illustrates an exemplary conventional approval process where an order is submitted for approval;

FIG. 3 illustrates a sample conventional approval state machine using null events for automatic approvals based upon the value of the order;

FIG. 4 illustrates an exemplary state machine for managing an order process in accordance with the present invention;

FIG. 5 illustrates exemplary software code that may be invoked during an entry action in accordance with the present invention; and

FIG. 6 illustrates an exemplary network environment in which the present invention can operate.

### DETAILED DESCRIPTION OF PREFERRED EMBODIMENTS

The present invention provides an improved technique for automatic transitions in a state machine that manages a business process. As discussed below, the present invention provides an improved method for implementing complex decision-making logic in one place.

### State Machine Terminology

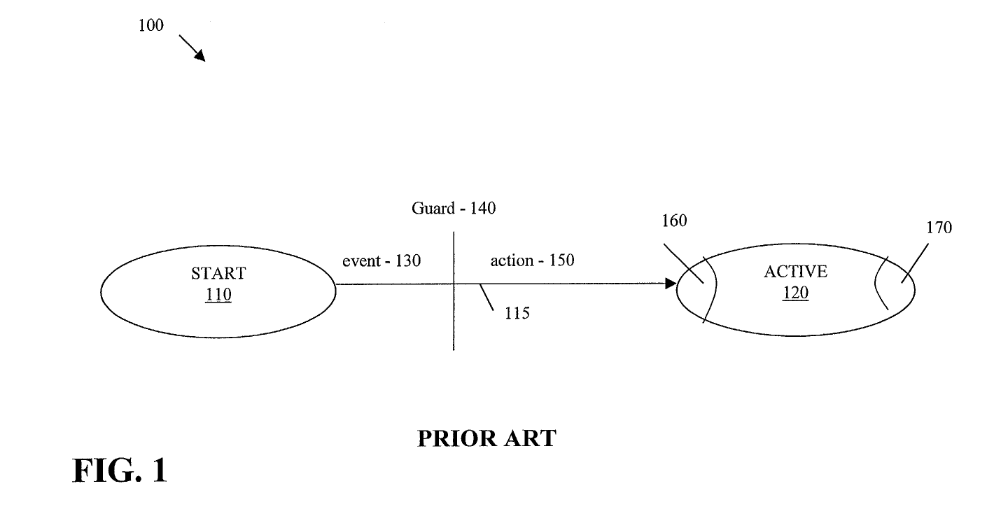

Business processes can be represented using a state machine. State machines provide a way to control the set of events and actions that may be performed throughout the life cycle of a business object. The Unified Modeling Language (UML) provides a standardized syntax for describing state machines. FIG. 1 illustrates an exemplary state machine 100 having two states 110, 120 with a single transition 115 leading from the Start state 110 to the Active state 120. The transition 115 is composed of three parts. First, there is an event 130 that defines what may cause this transition 115 to be attempted. Second, one or more guards 140 determine whether or not the transition 115 may be taken based upon some predefined criteria, such as the authority of the user or certain values associated with the business object. Finally, the action 150 provides a means for identifying logic that may act upon, or on behalf of, the object being managed by the state machine 100. Thus, if the transition 115 is allowed according to the guards 140, then the action 150 is performed and the object moves into the Active state 120. The various components of a transition 115 can be expressed using the notation “event [guard] action.”

In addition, UML allows entry and exit actions to be associated with any state, such as the state 120. An entry action 160 is logic that is executed upon entering a state, and is typically used to clean up from the transition or initialize state information. An exit action 170 is logic executed upon leaving a state, and is typically used to perform some cleanup action associated with the state.

For a more detailed discussion of techniques for managing business processes using a state machine, see, for example, U.S. patent application Ser. No. 09/818,719, filed Mar. 27, 2001, entitled “E-Market Architecture for Supporting Multiple Roles and Reconfigurable Business Processes,” August-Wilhelm Scheer, Aris—Business Process Modeling, Springer Verlag, 1999 or Peter Muth et al., Enterprise-Wide Workflow Management Based on State and Activity Charts, in A. Dogac, L. Kalinichenko, T. Ozsu, A. Sheth (Editors), Workflow Management Systems and Interoperability, Springer Verlag, 1998, each incorporated by reference herein.

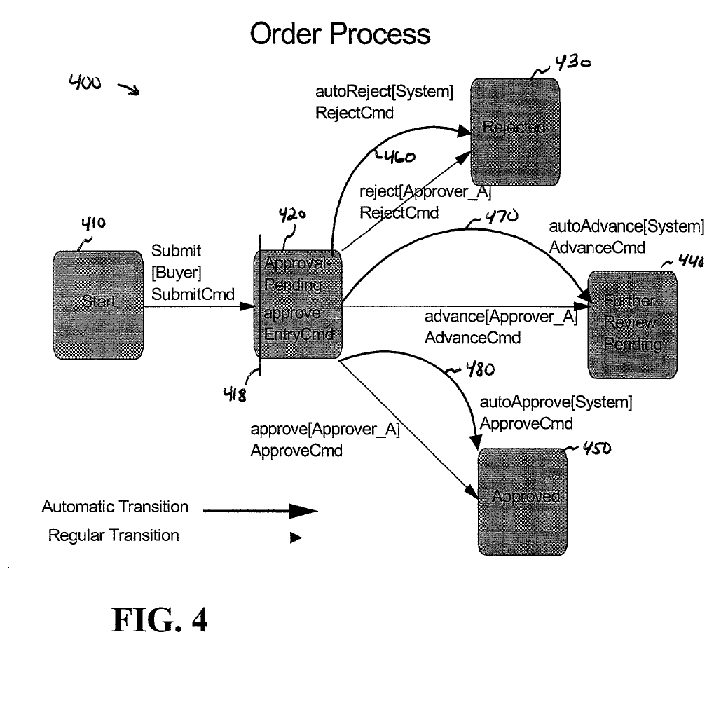

The present invention is focused on the entry action 160. As discussed further below in conjunction with FIG. 4, the present invention expands the concept of what can be done from within an entry action. The present invention thus provides a method to implement complex decision-making logic in one place (as opposed to being distributed across several guards). By placing the complex decision-making logic in an entry action, it is easier to define and maintain the logic, as well as to maintain consistency with respect to the set of options defined. If the logic was distributed across several places, as described earlier with the UML examples, additional time may be used or incorrect processing may occur. The programmer who codes the decision-making logic using the approach of the present invention is now free to use one of the many decision-making constructs with which they are already accustomed, including if-then-else and switch statements. Also, this logic may be far more sophisticated than that used in a simple UML guard. The result is that the present invention is more powerful and the logic is easier to understand.

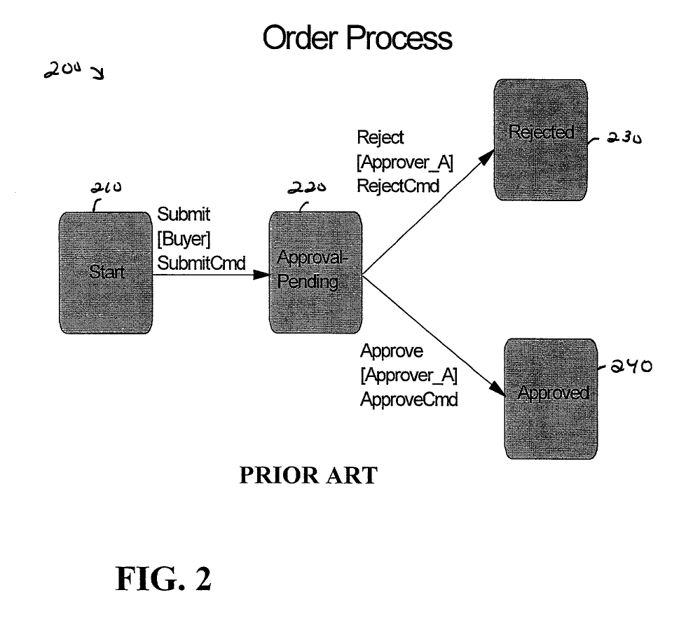

FIG. 2 illustrates an exemplary conventional approval process 200, where an order is submitted for approval. When the order is submitted by an authorized user, perhaps by clicking a submit button on a web page (not shown) from a browser, the order moves from a start state 210 into an approval pending state 220 where another authorized user is expected to make the decision to approve or reject the order. More specifically, when a user with “buyer” authority submits an order for approval, the order moves to the approval-pending state 220. Once the decision is made by a user with “Approver_A” authority, then the order moves into either the rejected state 230 or the approved state 240.

### Automated Decision Making

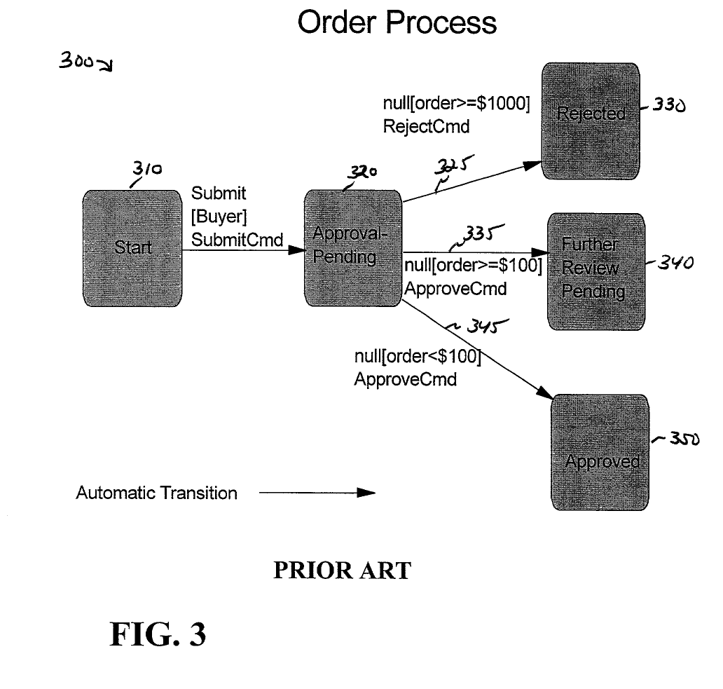

UML provides a method to allow transitions to be automatically traversed without events, by defining transitions with NULL events. FIG. 3 illustrates a sample conventional approval state machine 300 where approvals are automatic based upon the value of the order. If the order is less than $100, then the order is automatically approved. If the order is $1000 or more, then the order is automatically rejected. Otherwise, the order is sent for further review. Upon entering the approval-pending state 320, a workflow manager will check all transitions which have NULL events defined. Since all three transitions 325, 335, 345 have NULL events, their guards are checked to determine which transition may be taken.

Thus, as shown in FIG. 3, when a business flow enters a state, such as state 320, a workflow manager (not shown) may check all defined transitions leaving that state to determine if there are any transitions with NULL events. If they exist, then the workflow manager will test the guards for each of these transitions to determine whether or not one of them may be taken. This approach, however, has several drawbacks.

The first drawback is that it requires the workflow manager to, potentially, examine many transitions. The effort to find the transitions with NULL events and evaluate all of their guards could have a performance impact on the system. Another drawback is that there may be multiple transitions that meet the automatic criteria. In the example of FIG. 3, there are two transitions 325, 335 having guards that are satisfied by an order for greater than $1000. Transition 325 results in the order being rejected, while transition 335 leads to further review of the order. In this situation, unless the transitions 325, 335 are given some priority order or every transition is created with guards that are mutually exclusive and account for every business situation, the transition selected by the workflow manager may not be the one originally intended by the business process creator. This example illustrates that all guards must be carefully designed and that if conditions change, then multiple guards must be updated.

### Enhanced Entry Actions

The present invention provides an improved technique for automatically transitioning between states in a state machine that manages a business process. The present invention expands the concept of what can be done from within an entry action. Specifically, the present invention provides for automatic state transitions by throwing events upon state entry whenever any conditions associated with the entry action are satisfied. Thus, instead of performing a simple cleanup or initialization, as discussed above in conjunction with FIG. 1, the present invention allows entry actions to contain arbitrarily complex logic, including business decision logic, which may in turn raise an event which will cause a specific next transition to be taken.

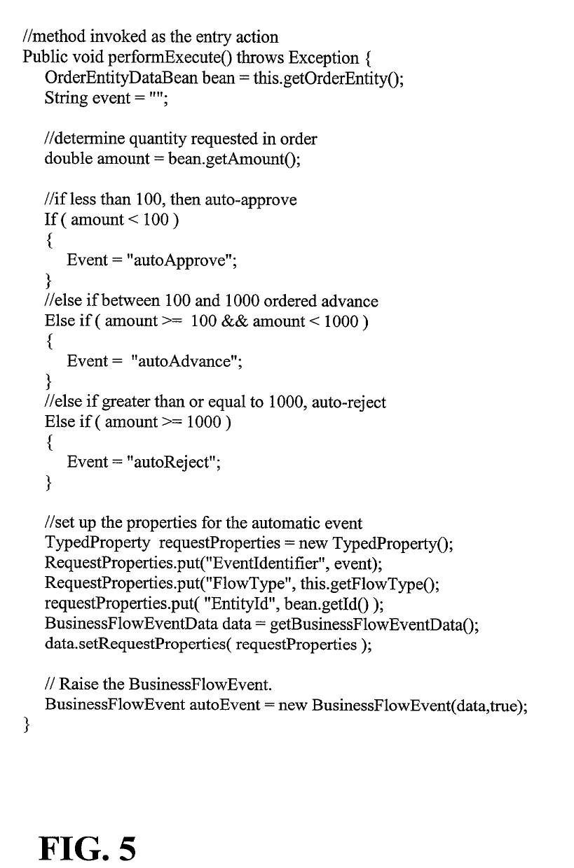

FIG. 4 illustrates an exemplary state machine 400 for managing an order process in accordance with the present invention. When an object enters the approval-pending state 420, an entry action 418 is executed. This entry logic may examine a wide range of information including the total purchase price of the order and information about the submitter, and then make an informed decision about whether or not this order qualifies for automatic transition to another state. Exemplary logic for the entry action 418 is discussed below in conjunction with FIG. 5. If the order does qualify, then the entry action 418 raises the AutoReject event 460, AutoAdvance event 470 or AutoApprove event 480, to the corresponding Rejected state 430, Further Review Pending state 440 or Approved state 450, thereby causing the appropriate transition to be taken out of the state 420. If the order falls outside of the specified criteria, the order will remain in the approval-pending state 420 for an authorized approver to manually approve or reject it.

Thus, the entry action 418 for the approval-pending state 420 determines if any automatic transitions can be automatically taken if certain business conditions are satisfied. The entry action 418 will then raise the event for the appropriate automatic transition. If no conditions are met for an automatic transition, the entry action 418 will not raise an event and the object will remain in the approval-pending state 420. In this exemplary case, the decision logic is based upon the total purchase price of the order. The decision making logic could be far more complex, however, as would be apparent to a person of ordinary skill in the art.

NULL events may still play a role in triggering automatic transitions, using the approach discussed above in conjunction with FIG. 3, however, the present invention significantly reduces the need for them while overcoming many of the problems which are encountered with using NULL events in decision-making scenarios.

The present invention resolves some other problems as well. In order to allow a business process to be shared among businesses with differing numbers of approvals required, the entry action logic for each approval state could check for the nature of the approvals required by the organization which owns the object, and if this level is not needed, automatically raise an event to take the object past the Approval-Pending state. One possible implementation is discussed in our co-pending patent application entitled “Method and Apparatus for Creating and Managing Complex Business Processes,” filed contemporaneously herewith.

Another potential benefit of this approach is the ability to quickly modify a state machine by changing the entry action for the state where the change is to take place. For example, if a particular state is no longer considered to be useful to the user community, then by changing the entry action to automatically throw an event that will force the object in the desired direction, the state will be skipped, and no objects would ever remain in that state. This is all done without modifying the state machine itself, which may require a greater amount of expertise and care. Or this technique could provide a simple way to test state machine changes before actually modifying the state machine itself.

FIG. 5 illustrates exemplary software code that may be invoked during an entry action in accordance with the present invention. As shown in FIG. 5, the code several criteria, such as “less than 100” or “between 100 and 1000 ordered” causing automatic transitions to the Approved or Further Review Pending states, respectively.

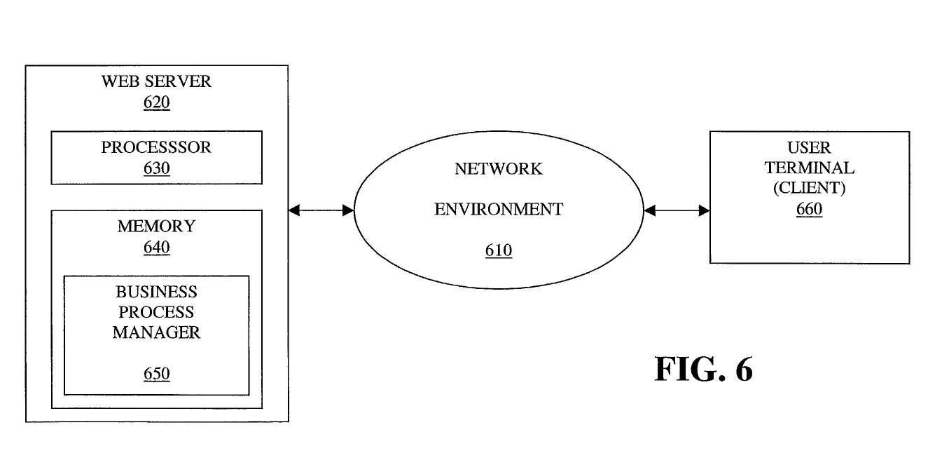

FIG. 6 illustrates an exemplary network environment 610 in which the present invention can operate. As shown in FIG. 6, a web server 620 communicates over a network 610 with a user terminal 660. For example, the user 660 may submit an order for goods or services to the web server 620. The approval process that determines whether the submitted order is approved or denied may be managed in accordance with a business process manager 650 incorporating features of the present invention, as discussed above in conjunction with FIG. 4. The network 610 can be any wired or wireless network for transferring information, such as a data network or a telephone network.

Memory 640 will configure the processor 630 to implement the methods, steps, and functions disclosed herein. The memory 640 could be distributed or local and the processor 630 could be distributed or singular. The memory 640 could be implemented as an electrical, magnetic or optical memory, or any combination of these or other types of storage devices. The term “memory” should be construed broadly enough to encompass any information able to be read from or written to an address in the addressable space accessed by processor 630. With this definition, information on a network 610 is still within memory 640 of the web server 620 because the processor 630 can retrieve the information from the network 610.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the embodiments and variations shown and described herein are merely illustrative of the principles of this invention and that various modifications may be implemented by those skilled in the art without departing from the scope and spirit of the invention.

What is claimed is:

1. A method for managing a business process using a state machine, said state machine having a plurality of states, at least one of said states including an entry action, said entry action including logic executed upon entering said state, said method comprising the step of:
providing conditional logic in said entry action, said entry action causing an automatic transition to another state if said conditional logic is satisfied.

2. The method of claim 1, wherein said entry action is associated with an approval pending state and includes conditional logic for specifying a threshold when an affirmative approval is required and wherein said entry action causes a transition to bypass said approval pending state if said threshold is not exceeded.

3. The method of claim 1, wherein said state machine is modified by changing an entry action for a state where a change is to take place.

4. The method of claim 3, wherein said entry action is associated with a state that is no longer useful and wherein said entry action includes logic that causes an object to bypass said state in a desired direction.

5. A method for managing a business process using a state machine, said state machine having a plurality of states, at least one of said states including an entry action, said entry action including logic executed upon entering said state, said method comprising the steps of:
evaluating said entry action upon entering said state, said entry action including conditional logic; and
transitioning to another state if said conditional logic is satisfied.

6. The method of claim 5, wherein said entry action is associated with an approval pending state and includes conditional logic for specifying a threshold when an affirmative approval is required and wherein said entry action causes a transition to bypass said approval pending state if said threshold is not exceeded.

7. The method of claim 5, wherein said state machine is modified by changing an entry action for a state where a change is to take place.

8. The method of claim 7, wherein said entry action is associated with a state that is no longer useful and wherein said entry action includes logic that causes an object to bypass said state in a desired direction.

9. A system for managing a business process, comprising:
a memory that stores computer-readable code; and
a processor operatively coupled to said memory, said processor configured to implement said computer-readable code, said computer-readable code configured to:
provide conditional logic in said entry action, said entry action causing an automatic transition to another state if said conditional logic is satisfied.

10. The system of claim 9, wherein said entry action is associated with an approval pending state and includes conditional logic for specifying a threshold when an affirmative approval is required and wherein said entry action causes a transition to bypass said approval pending state if said threshold is not exceeded.

11. The system of claim 9, wherein said state machine is modified by changing an entry action for a state where a change is to take place.

12. The system of claim 10, wherein said entry action is associated with a state that is no longer useful and wherein said entry action includes logic that causes an object to bypass said state in a desired direction.

13. A system for managing a business process, comprising:
a memory that stores computer-readable code; and
a processor operatively coupled to said memory, said processor configured to implement said computer-readable code, said computer-readable code configured to:
evaluate said entry action upon entering said state, said entry action including conditional logic; and
transition to another state if said conditional logic is satisfied.

14. The system of claim 13, wherein said entry action is associated with an approval pending state and includes conditional logic for specifying a threshold when an affirmative approval is required and wherein said entry action causes a transition to bypass said approval pending state if said threshold is not exceeded.

15. The system of claim 13, wherein said state machine is modified by changing an entry action for a state where a change is to take place.

16. The system of claim 15, wherein said entry action is associated with a state that is no longer useful and wherein said entry action includes logic that causes an object to bypass said state in a desired direction.

17. An article of manufacture for managing a business process, comprising:
a computer readable medium having computer readable code means embodied thereon, said computer readable program code means comprising:
a step to provide conditional logic in said entry action, said entry action causing an automatic transition to another state if said conditional logic is satisfied.

18. An article of manufacture for managing a business process, comprising:
a computer readable medium having computer readable code means embodied thereon, said computer readable program code means comprising:
a step to evaluate said entry action upon entering said state, said entry action including conditional logic; and
a step to transition to another state if said conditional logic is satisfied.
